(19) United States
(12) Patent Application Publication
(10) Pub. No.: US 2003/0109252 A1
(43) Pub. Date: Jun. 12, 2003

(54) System and method of codec employment in a cellular telephone

(75) Inventors: Andrew Kevin Prentice, Pleasanton, CA (US); Steven Werden, Bridgewater, NJ (US)

Correspondence Address: Corporate Patent Counsel, Philips Electronics North America Corporation, 580 White Plains Road, Tarrytown, NY, 10591, US

(73) Assignee: KONINKLIJKE PHILIPS ELECTRONICS N.V.

(21) Appl. No.: 10/015,844

(22) Filed: Dec. 10, 2001

(51) Int. Cl. H04M 3/00

(52) U.S. Cl. 455/418; 455/419

(57) ABSTRACT

The present invention is directed to a cellular phone communication device comprised of a radio frequency module configured to receive and send communication data. A codec controller is provided, coupled to the radio frequency module and configured to identify data portions related to an executable codec file. A codec engine is coupled to the codec controller, configured to store an executable codec file received by the communication device and identified by the codec controller.

### FIELD OF THE INVENTION

This invention relates to a communication system and more specifically to a system for employing coding and decoding technology in communications networks and more particularly in wireless communications networks, such as cellular phones.

### BACKGROUND OF THE INVENTION

Within the last few years, mobile communication devices have experienced an increasing demand for channel capacity, to send and receive voice and other multimedia data. To this end, various wireless communication systems use coding and decoding techniques and systems, referred to as codecs, to compress data and to comply with various file type protocols.

For example, as third generation (3G) cellular telecommunications systems are deployed, there will be a large increase in the number of codecs, a wireless device, such as a cellular phone has to support. Apart from the traditional cellular vocoders in both 2G and 3G systems, wireless devices may need to support Voice over IP vocoders, real time audio codecs, such as Real Audio® and MP3® and video codecs, such as MPEG4.

Prior art mobile devices, such as cellular phones, use dedicated hardware to support one or more codec systems to perform coding and decoding functions. Other mobile devices also use digital signal processors that support such coding and decoding operations. However, the increase in the number of codecs that must be supported requires either an increase in the hardware complexity or an increase in the size of the digital signal processor code memory, both of which lead to higher costs.

Thus, there is a need for an improved mobile communication device that can easily and inexpensively support a plurality of coding and decoding protocols or codecs.

### SUMMARY OF THE INVENTION

In accordance with one embodiment of the invention, a communication system is configured to allow the transmission of a codec protocol to the remote device on a per session basis. For example, at the start of a videoconference, an MPEG4 codec would be downloaded to the remote device, such as a cell phone, and for a cellular voice call a vocoder would be downloaded.

In accordance with another embodiment of the invention, a codec layer is added to the packet being transmitted, either in a packet switched network, or in a circuit switched network. The codec layer may include a header portion and a codec portion. Once the data packet is received to its intended target, the codec header indicates that a codec portion associated with it has been transmitted. Thereafter, the codec portion is downloaded to the mobile device so that data packets identified by that codec can be handled in accordance with the downloaded coded specifications.

In accordance with another embodiment of the invention, a plurality of codec portions can be downloaded in a mobile device, so that each data packet identified by a corresponding codec type can be handled accordingly. The codec portion includes a codec executable code or file that is executed by the mobile device after its download. This codec executable code could be in a number of formats, such as a platform neutral Java, a hardware code for a programmable hardware, or a system controller compatible code.

### BRIEF DESCRIPTION OF THE DRAWINGS

FIG. 1 illustrates is a block diagram of a communication transmission plane employing a codec layer in accordance with one embodiment of the present invention;

FIG. 2 is a diagram illustrating the structure of a communication packet employed in a circuit switched network in accordance with one embodiment of the invention;

FIG. 3 is a diagram illustrating the structure of a communication packet employed in a packet switched network in accordance with one embodiment of the invention;

FIG. 4 is block diagram of a mobile handset device in accordance with one embodiment of the invention;

FIG. 5 is a functional block diagram of a mobile handset device in accordance with one embodiment of the invention; and

FIG. 6 is a flow chart illustrating the process of transmitting a downloadable codec layer in accordance with one embodiment of the invention.

### DETAILED DESCRIPTION OF THE DRAWINGS

In accordance with one embodiment of the invention, an executable codec file is prepended to the stream of data to be decoded by a mobile device, such as a mobile phone.

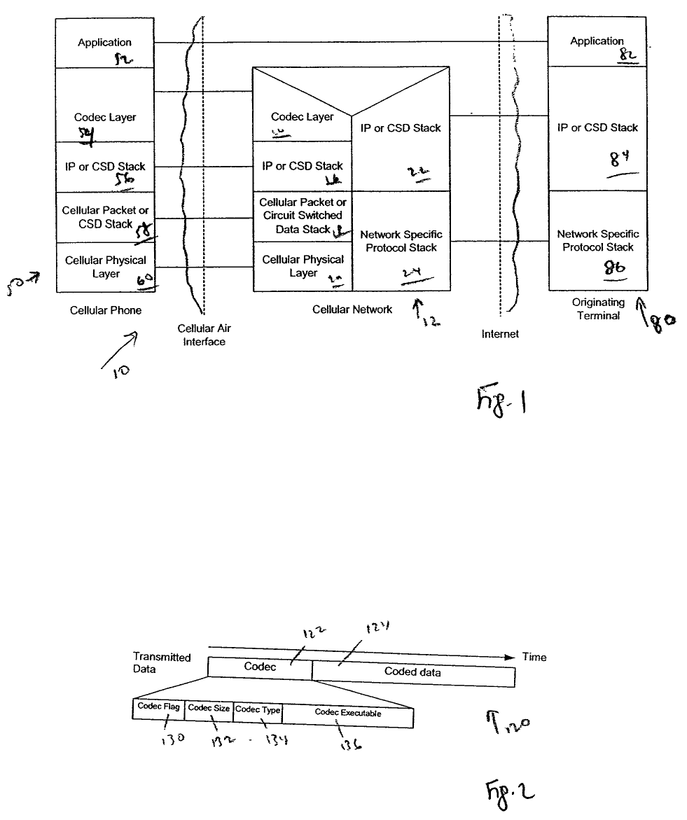

FIG. 1 illustrates a communication system transmission plane 10 in accordance with one embodiment of the invention, although the invention is not limited in scope in that respect. Transmission plane 10 illustrates various headers and protocols that are employed when constructing and transmitting data packets.

A cellular network 12 is configured to handle communications made between a plurality of mobile phones among each other, or with other devices and terminals coupled to the Internet. To this end, cellular network 12 includes two interfaces that are configured to provide interface functions between cellular phones and the network on one side, and to provide interface functions between the network and terminals connected to the Internet on the other. This dual interface capability allows both Internet devices and cellular phone devices communicate via the cellular network.

FIG. 1 illustrates the corresponding communication layers employed in each of the two interfaces of the cellular network. The cellular phone interface section includes a codec layer 14, an IP stack 16, a cellular packet circuit switched data stack 18 and a cellular physical layer 20. Similarly, the Internet interface section includes an IP stack 22, and a network specific protocol stack 24.

Codec layer 14 is configured to prepend or encapsulate a pre-defined codec file and to process data packets that travel through cellular network 12, as will be described in more detail hereinafter.

The remaining communications layers are typically employed in a conventional cellular network. For example, cellular network 12 includes an IP or CSD stack 16, as is known by those skilled in the art. Thus, if the communication mode is based on a packet switching arrangement, the IP stack provides for all the proper header information to be added to the data. Otherwise, if the communication mode is based on circuit switching mode, CSD (circuit switched data) stack provides for all the proper header information to be added for a circuit switched connection. IP or CSD stack 22 functions similarly for operations involving an interface with the Internet.

Cellular network 12 also includes a cellular packet or circuit switched data stack layer 18, configured to handle communications based on cellular packet standards or in the alternative based on circuit switched data stack standards.

Cellular physical layer 20 is configured to function to provide proper information to handle the actual physical connection among various cellular devices in the network. Similarly, network specific protocol stack layer 24 is configured to handle proper connections between various terminals coupled to the cellular network via the Internet.

FIG. 1 also illustrates various layers employed by each cellular phone, such as 50, which communicates via the cellular network. These layers include: an application layer 52, which is configured to provide an interface between the user and the cellular phone device; a codec layer 54, which is configured to handle and identify codec related information that are sent or received by the cellular phone device; an IP or CSD stack 56, which is configured to handle packet switched or circuit switched data communication; a cellular packet or CSD stack 58, which is also configured to handle cellular phone or circuit switched phone connections; and a cellular physical layer 60, which is configured to handle the physical connection of cellular devices via the cellular network.

FIG. 1 also illustrates various layers employed by each Internet terminal, such as 80, which communicates via the cellular network. These layers include: an application layer 82, which is configured to provide an interface between the user and the cellular phone device; an IP or CSD stack 84, which is configured to handle packet switched or circuit switched data communication; and a network specific protocol stack 86, which is configured to handle physical communication between the Internet terminal and the cellular network.

FIG. 2 illustrates the data structure of a communication packet 120 employed in a circuit switched data arrangement in accordance with one embodiment of the invention. Communication packet 120 includes a first portion 122 that includes codec related information and a second portion 124 that includes the coded data that is being transmitted. It is noted that for a circuit switched data communication arrangement, a physical link is established between two communicating terminals, for an entire communication session. Thus, preferably, the data exchanged between two terminals, include the header codec related portion 122 and the remainder coded data portion 124.

The codec related portion 122 includes additional portions, such as a codec flag field 130, a codec size field 132, a codec type field 134 and a codec executable field 136. The coded flag field includes information that indicates that portion 122 contains a downloadable codec file. Codec size field 132, includes information that indicates the size of the codec executable file that is downloaded to a receiving terminal. Codec type field 134 contains information that is employed to associate the remaining coded data in the coded data portion, with the corresponding codec file, so that a receiving terminal can handle multiple streams of data with different codecs simultaneously. Codec executable field 136 includes an executable coding/decoding file that can be in many formats, such as DSP or system specific code, platform neutral code (e.g. Java) and a hardware code for programmable hardware.

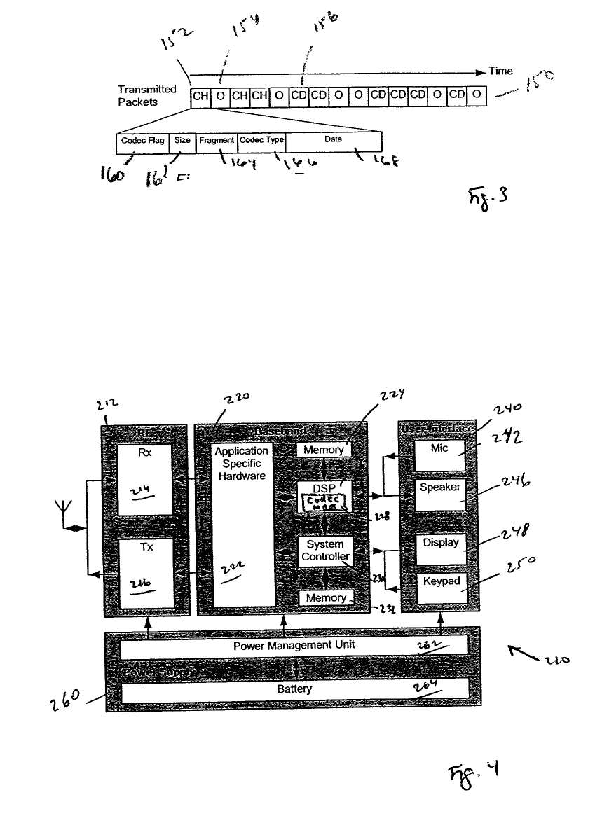

FIG. 3 illustrates the data structure of communication packets 150 employed in a packet switched data arrangement in accordance with one embodiment of the invention. Communication packets 150 include codec header (CH) packets 152, other packets 154, and codec data packets 156.

Codec header packets 152 contain various fields, such as codec flag field 160, codec size field 162, a codec fragment field 164, a codec type field 166 and codec data field 168. Codec flag field 160 contains information that indicates that this portion of the message includes a downloadable codec file.

Codec size field 162 includes information that indicates the size of the codec executable file that is downloaded to a receiving terminal. Codec fragment field 164 includes information whether the codec header packet 152 is the final packet comprising the codec information or whether there are more packets to be received in order to have a complete codec related information at a receiving terminal.

Codec type field 166 contains information that is employed to associate the remaining coded data in the coded data portion, with the corresponding codec file, so that a receiving terminal can handle multiple streams of data with different codecs simultaneously.

Codec data field 168 contains either portions of the executable coding/decoding file or the data that needs to be decoded. It is noted that codec data packets 156 contain the data that needs to be decoded, along with the type of codec that needs to be used in order to decode the data. The codec executable data can be in many formats, such as DSP or system specific code, platform neutral code (e.g. Java) and a hardware code for programmable hardware

FIG. 4 is a block diagram of a cellular mobile handset 210 in accordance with one embodiment of the present invention. Handset 210 includes an RF module 212, a baseband module 220, a user interface module 240 and a power supply module 260.

RF module 212 includes a receiver 214, which is configured to perform the function of converting the incoming RF signal to a low frequency signal so as to allow the baseband module to process the converted signal. Module 212 also includes a transmitter 216, which is configured to perform the function of converting the low frequency signal from the baseband to the required RF frequency. Both modules 214 and 216 are coupled to the handset's antenna for sending and receiving communication signals.

Baseband module 220, includes an application specific hardware module 222, which is configured to extract user and control information from the low frequency signal supplied by the RF module and combine user and control information to generate a low frequency signal provided to RF module 212.

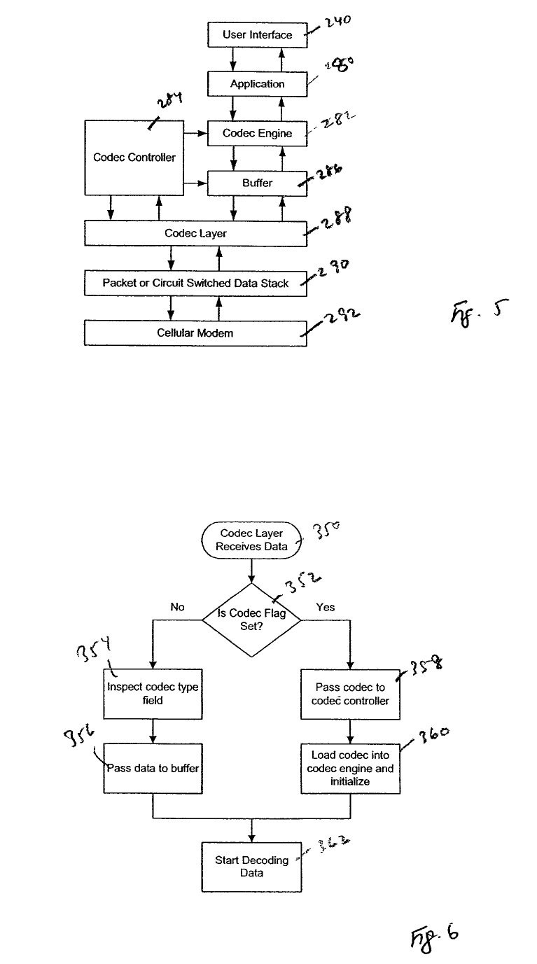

A digital signal processor (DSP) module 226 is coupled to module 222 and to an associated memory 224. DSP module 226 is configured to perform signal-processing tasks such as voice coding and audio processing. DSP module 226 includes a codec module 228, which is configured to perform codec functions, in accordance with the codec files that have been transmitted to the handset, as explained in more detail in accordance with FIG. 5.

Baseband module 220 also includes a system controller 230, and associated memory 232, which is configured to control various components of handset 210, and to provide general computing power for executing such tasks as handling protocol stacks associated with the cellular communication standard, handling functions associated with graphical user interface functions and handling user applications.

User interface module 240 includes a microphone unit 242, a speaker unit 246, a display unit 248 and a keypad 250. It is noted that display 248 when used with keypad 250 allows the user to control the handset and to view web pages or streaming video that has been sent via the Internet and the cellular network as discussed in connection with FIG. 1.

Power management module 260 includes a power management unit 262, which ensures that each part of the handset receives the correct power when needed, and a battery unit 264, which is the primary power source for the handset. The function of various components of the handset relating to the codec related information is discussed in more detail hereinafter.

FIG. 5 illustrates a functional diagram of various modules employed by handset 210 in accordance with one embodiment of the invention. It is noted that the functions of these modules can be performed by one or many components described in FIG. 4. Thus, in accordance with one embodiment of the invention, user interface 240 is coupled to an application 280, which is configured to process the codec related information.

Application module 280 is coupled to a codec engine 282, which is configured to receive and store a codec executable file, as specified by the codec related data received by the handset. Codec engine 282 is coupled to a codec controller 284 and to a data buffer 286. Buffer 286 and codec controller 284 are both coupled to a codec layer 288, which in turn is coupled to a packet or circuit switched data stack 290, which in turn is coupled to a cellular modem 292.

In accordance with one embodiment of the invention, system controller 230 (FIG. 4) is responsible to handle the functionality of codec layer 288. Codec layer 288 is configured to interpret and strip the headers from codec related and data streams. Codec controller 284, receives and handles the codec executable file, so as to allow the handset to code and decode related data based on that file. To this end, codec controller 284 loads one of the received codecs into codec engine 282. The codec engine is the resource that runs the codec executable code. It is noted that in accordance with various embodiments of the invention, the codec engine function is performed by the system controller, the DSP module or a re-programmable hardware system, which may be contained within hardware module 222.

Codec controller 284 also controls buffer 286. The buffer temporarily stores the data that need to be coded and decoded while the applicable codec file is loaded into the codec engine.

FIG. 6 illustrates the process for receiving applicable codec related data and processing the data in accordance with one embodiment of the invention. At step 350 codec layer 288 receives data via the cellular network. At step 352, codec controller 284 determines whether the codec flag field is set. If so, codec controller 284 expects that this portion of the codec related data includes an executable codec file. To this end, at step 358, the executable codec file is passed to codec controller 284 and at step 360 the codec file is loaded into codec engine 282. It is noted that codec controller 284 in accordance with another embodiment of the invention is configured to store the received executable codec file for a specified duration, so that various data coded by various codec formats can be processed simultaneously.

If at step 352 codec flag field is not set, codec controller 284, at step 354 inspects codec type field so as to associate the incoming coded data with the corresponding codec file. Codec controller 284 also loads the codec engine 282 with the corresponding codec file. At step 356 the incoming data is passed to data buffer 286. At step 362, codec engine 282 begins to decode the incoming data.

It is noted that in accordance with one embodiment of the invention, codec layer 288 may include additional management capabilities. For example, codec layer 288, incorporates additional fields to contain information indicating the codec capabilities of the handset to the codec layer entity in the cellular network. The codec layer entity in the cellular network would then add the codec header portion with executable codec information only for those data streams for which there is no codec available in the handset. Furthermore, the handset stores the codecs that are downloaded to it and update its capability report accordingly.

It is noted that the codec engine of the mobile handset is configured in accordance with one embodiment of the invention, to both decode incoming data and code outgoing data in accordance with the codec file.

Thus, the present invention allows the use of a multitude of codecs in cellular communication networks, wherein an additional codec layer in the communication protocol allows for dynamically receiving these multitude of codecs along with their associated data, and downloading these codes as the data is received by the handset.

While only certain features of the invention have been illustrated and described herein, many modifications, substitutions, changes or equivalents will now occur to those skilled in the art. It is therefore, to be understood that the appended claims are intended to cover all such modifications and changes that fall within the true spirit of the invention.

We claim:

1. A cellular phone communication device comprising:
a radio frequency module configured to receive and send communication data;
a codec controller coupled to said radio frequency module and configured to identify data portions related to an executable codec file; and
a codec engine coupled to said codec controller, said codec engine configured to store an executable codec file received by said communication device and identified by said codec controller.

2. The cellular phone communication device according to claim 1 further comprising a memory unit for storing a plurality of executable codec files received by said device.

3. The cellular phone communication device according to claim 2, wherein said codec controller provides at least one of said plurality of executable codec files to said codec engine.

4. The cellular phone communication device according to claim 2, wherein said communication data are coded in accordance with a circuit switched data arrangement.

5. The cellular phone communication device according to claim 4 wherein said communication data includes a codec portion and a coded data portion.

6. The cellular phone communication device in accordance with claim 5, wherein said codec portion includes a codec executable file, that is downloaded in said codec engine for coding data received in said coded data portion.

7. The cellular phone communication device in accordance with claim 6 wherein said codec portion further comprises a codec flag containing information that indicate presence of an executable codec file and a codec type that contains information that associates coded data with a corresponding executable codec file, so that said codec engine receives an executable codec file associated with an incoming coded data.

8. The cellular phone communication device according to claim 2, wherein said communication data are coded in accordance with a packet switched data arrangement.

9. The cellular phone communication device according to claim 8 wherein said communication data includes a plurality of codec header packets and codec data packets.

10. The cellular phone communication device in accordance with claim 9, wherein said codec header packets include a codec executable file in a data field, said executable file is downloaded in said codec engine for coding data received in said codec data packets.

11. The cellular phone communication device in accordance with claim 10 wherein said codec header packet further comprises a codec flag containing information that indicate presence of an executable codec file and a codec type that contains information that associates coded data with a corresponding executable codec file, so that said codec engine receives an executable codec file associated with an incoming coded data.

12. The cellular phone communication device in accordance with claim 11, wherein said codec header packet further comprises a fragment field that contains information indicating whether a packet is a final packet comprising a codec executable file.

13. A cellular network system for enabling communication among a plurality of cellular phone devices, said network system comprising:
a cellular network for routing communication data, said cellular network comprising a codec handling layer configured to add codec related information to said communication data, including a codec executable file;
a plurality of phone devices coupled to said cellular network, said phone devices having a codec controller configured to identify said codec related information.

14. The system in accordance with claim 13, wherein said cellular network is further coupled to a plurality of terminals via Internet, so as to route said communication data among said cellular phone devices and said terminals.

15. The system in accordance with claim 14, wherein said phone devices further comprise a codec engine configured to execute a codec executable file received from said cellular network.

16. The system in accordance with claim 15, wherein said codec engine decodes data received from said cellular network in accordance with said received codec executable file.

17. A method in a cellular phone device for receiving and transmitting communication data via a cellular communication network, said method comprising the steps of:
a) receiving a plurality of communication data, said communication data including a codec related portion and a corresponding data related portion, said codec related portion including a codec executable file for decoding data contained in said data related portion;
b) processing said codec executable file, such that said corresponding data related portion is decoded in accordance with said codec executable file; and
c) coding communication data generated in said cellular phone device in accordance with said codec executable file, for transmission to said cellular network.

18. The method in accordance with claim 17 further comprising the step of encapsulating said codec related information to a circuit switched communication data.

19. The method in accordance with claim 17, further comprising the step of encapsulating said codec related information to a packet switched communication data.
